(19) United States
(12) Patent Application Publication
(10) Pub. No.: US 2023/0024296 A1
(43) Pub. Date: Jan. 26, 2023

(54) FILAMENT COMPRISING A THERMOPLASTIC POLYIMIDE AND THREE-DIMENSIONAL BODY MADE FROM THE FILAMENT

(71) Applicant: ZYMERGEN INC., Emeryville, CA (US)

(72) Inventors: Patrick Gerardus DUIS, Bergeijk (NL); Kenneth Angus KEMPINSKI, Mount Pleasant, SC (US); Justin KERSZULIS, San Leandro, CA (US)

(21) Appl. No.: 17/810,088

(22) Filed: Jun. 30, 2022

Related U.S. Application Data
(60) Provisional application No. 63/217,233, filed on Jun. 30, 2021.

(51) Int. Cl. C08G 73/10; C08L 79/08

(52) U.S. Cl. CPC C08G 73/1067; C08L 79/08

(57) ABSTRACT

In one embodiment, a filament can comprise a thermoplastic polyimide, wherein the filament is adapted for use in a fused filament fabrication process and the thermoplastic polyimide may have a glass transition temperature not greater than 215° C. Three-dimensional bodies can be printed with the filament, wherein the three-dimensional bodies can have high strength values with even mechanical properties in printing direction and orthogonal to the printing direction.

### CROSS-REFERENCE TO RELATED APPLICATION(S)

The present application claims priority from U.S. Provisional Patent Application No. 63/217,233, filed Jun. 30, 2021, entitled “FILAMENT COMPRISING A THERMOPLASTIC POLYIMIDE AND THREE-DIMENSIONAL BODY MADE FROM THE FILAMENT,” naming inventors Patrick Gerardus DUIS, Kenneth Angus KEMPINSKI, and Justin KERSZULIS, which application is incorporated by reference herein in its entirety.

### FIELD OF THE DISCLOSURE

The present disclosure relates to a filament comprising a thermoplastic polyimide adapted for use in fused filament fabrication, a method of making the filament, a three-dimensional body made by fused filament fabrication using the filament, and a method of forming the three-dimensional body.

### BACKGROUND

Three-dimensional bodies containing high performance polymers and being made by fused filament fabrication have gained world-wide a strong interest. One precondition for manufacturing polymeric bodies via fused filament fabrication is that the polymers need to be thermoplastic polymers, while thermoset polymers are not suitable. The majority of commercially available polyimide polymers are thermoset materials. There exists a desire to form three-dimensional bodies via fused filament fabrication using thermoplastic polyimides having a low glass transition temperature, which can be made at low processing costs, and may compete in its property profile with high performance materials, such as PEEK, PEI, PEKK, PPS, PPA or PPSU.

### SUMMARY

According to one embodiment, a filament can comprise a thermoplastic polyimide, wherein the thermoplastic polyimide is a polymerization product of at least one diamine monomer and at least one dianhydride monomer, the diamine monomer being selected from

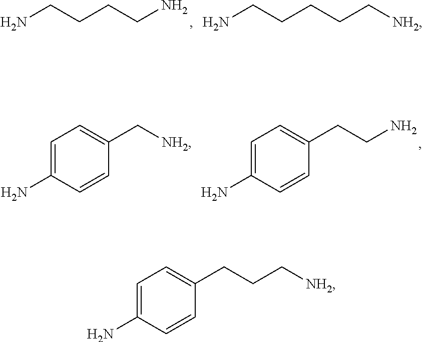 [SMILES: NCCCCN ; NCCCCCN ; NCc1ccc(N)cc1 ; NCCc1ccc(N)cc1 ; NCCCc1ccc(N)cc1]

or any combination thereof the filament is adapted for use in a fused filament formation process; and a glass transition temperature according to ASTM D7426 of the polyimide can be not greater than 215° C.

According to another embodiment, a method of forming a filament can comprise: providing a powder or a plurality of pellets, the powder or plurality of pellets including a thermoplastic polyimide; heating the powder or plurality of pellets to prepare a melt; and extruding the filament from the melt, wherein the thermoplastic polyimide is a polymerization product of at least one diamine monomer and at least one dianhydride monomer, the diamine monomer being selected from

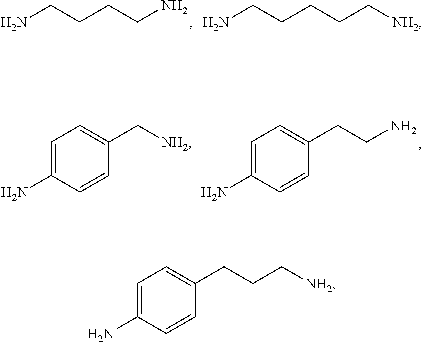 [SMILES: NCCCCN ; NCCCCCN ; NCc1ccc(N)cc1 ; NCCc1ccc(N)cc1 ; NCCCc1ccc(N)cc1]

or any combination thereof.

In another embodiment, a three-dimensional body can comprise a thermoplastic polyimide, wherein the thermoplastic polyimide is a polymerization product of at least one diamine monomer and at least one dianhydride monomer, the diamine monomer being selected from

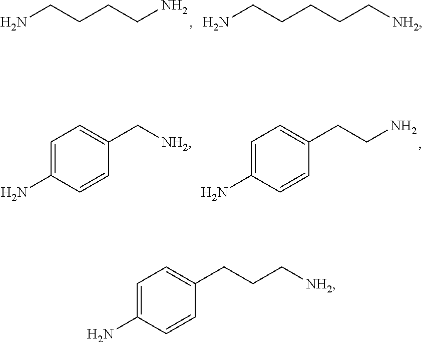 [SMILES: NCCCCN ; NCCCCCN ; NCc1ccc(N)cc1 ; NCCc1ccc(N)cc1 ; NCCCc1ccc(N)cc1]

or any combination thereof;
a glass transition temperature of the polyimide is not greater than 215° C.; the three-dimensional body is formed by a fused filament formation process, and a ratio of E₀ to E₉₀ is between 0.5:1 and 1:0.5, with E₀ being an elongation at break in printing direction and E₉₀ being an elongation at break in z-x direction, the elongation at break being measured according to ISO 527.

In yet another embodiment, a method of forming a three-dimensional body can comprise: melt extruding a plurality of layers using a filament; and fusing the plurality of layers to obtain the three-dimensional body, wherein the filament comprises a thermoplastic polyimide, the thermoplastic polyimide having a glass transition temperature of not greater than 215° C. and being a polymerization product of at least one diamine monomer and at least one dianhydride monomer, the diamine monomer being selected from

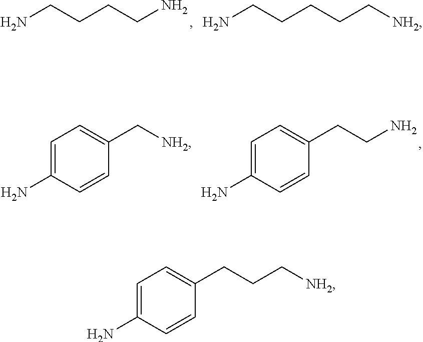 [SMILES: NCCCCN ; NCCCCCN ; NCc1ccc(N)cc1 ; NCCc1ccc(N)cc1 ; NCCCc1ccc(N)cc1]

or any combination thereof.

### BRIEF DESCRIPTION OF THE DRAWINGS

The present disclosure may be better understood, and its numerous features and advantages made apparent to those skilled in the art by referencing the accompanying drawings.

FIG. 1 includes an image illustrating the DSC curve of a polyimide material for making the filament of the present disclosure according to one embodiment.

FIG. 2 includes an illustration of the method of forming the filament according to one embodiment.

FIG. 3 includes line drawings illustrating FFF printed test specimens for measuring mechanical properties in printing direction, orthogonal to the printing direction, and 45 degrees to the printing direction according to embodiments.

FIG. 4A includes a scheme illustrating the forming of test specimen 3A of FIG. 3 according to one embodiment.

FIG. 4B includes a line drawing indicating the exact shape and dimensions of a test specimen for the mechanical testing according to ISO 359.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Various embodiments of the present disclosure will now be described, by way of example only, with reference to the accompanying drawings.

In one embodiment, the present disclosure relates to a filament comprising a thermoplastic polyimide, wherein the filament is adapted for use in a fused filament fabrication (FFF) process. As used herein, the term “filament”, if not indicated otherwise, refers to a filament adapted for the use in a fused filament fabrication process.

In one embodiment, the filament can comprise a thermoplastic polyimide, wherein the thermoplastic polyimide can be a polymerization product of at least one diamine monomer and at least one dianhydride monomer. In certain aspects, the diamine monomer can be selected from

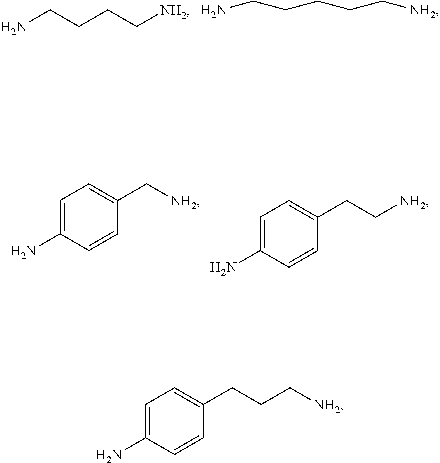 [SMILES: NCCCCCN ; NCCCCN ; NCc1ccc(N)cc1 ; NCCc1ccc(N)cc1 ; NCCCc1ccc(N)cc1]

or any combination thereof, and may have a glass transition temperature of not greater than 215° C. As used herein, the term “thermoplastic polyimide” relates to the above-described polyimide and more narrow structures thereof as described below, unless indicated otherwise.

In particular aspects, the glass transition temperature of the thermoplastic polyimide can be not greater than 210° C., or not greater than 205° C., or not greater than 200° C., or not greater than 195° C. In a further aspect, the glass transition temperature can be at least 130° C., or at least 140° C., or at least 150° C., or at least 160° C. As used herein, the glass transition temperatures are determined according to ASTM D7426, unless indicated otherwise.

In one embodiment, the dianhydride monomer of the thermoplastic polyimide can have a structure of Formula (1):

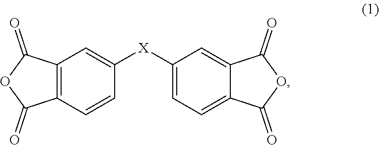

with X being CH₂, CHY, CY₂, or C₂-C₅ alkyl; Y being CH₃, CH₂F, CHF₂, or CF₃.

In a particular aspect, the dianhydride monomer can have the structure of formula (2):

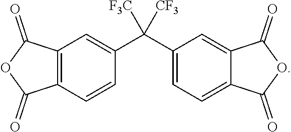 [SMILES: O=C1OC(=O)c2cc(C(c3ccc4c(c3)C(=O)OC4=O)(C(F)(F)F)C(F)(F)F)ccc21]

In a certain particular aspect, the thermoplastic polyimide can be a polymerization product of diamine

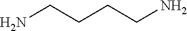

and dianhydride

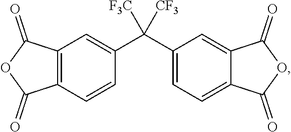 [SMILES: O=C1OC(=O)c2cc(C(c3ccc4c(c3)C(=O)OC4=O)(C(F)(F)F)C(F)(F)F)ccc21]

which leads to the polyimide with the recurring structure unit of Formula (3):

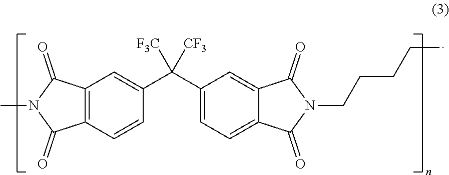

Methods for producing polyimides are well known to those of ordinary skill in the art, and any method may be employed to produce the polyimides of the present disclosure. In one aspect, the diamine and dianhydride monomers can be polymerized in high boiling solvents, such as dimethylacetamide (DMAc), N-methyl-2-pyrrolidone (NMP), or m-cresol, and may obtain at elevated temperatures the imidized polymer directly. In another aspect, the diamine and dianhydride monomers may be polymerized at low temperatures in a polar aprotic solvent, such as DMAc or NMP below 80° C., to yield in a first step a polyamic acid, which is in a second step imidized either chemically or thermally.

A molar ratio of the at least one diamine monomer and the at least one dianhydride monomer can be between 2:1 and 1:6, or between 0.9:1 and 1:6, between 0.9:1 and 1:4. In a certain particular aspect, the molar ratio can be from 0.9:1.05 to 0.95:1.1. After imidization, the obtained polyimides can be isolated by precipitation into a non-solvent (a liquid which does not dissolve the polyimide), for example, an alcohol. Typical non-solvents used for this purpose may be methanol or ethanol.

It has been surprisingly observed that the thermoplastic polyimide of the present disclosure can be very suitable for making a filament and forming with the filament a three-dimensional body via a fused filament fabrication process. The obtained three-dimensional polyimide-based bodies can have a property profile which can be similar or superior to the properties of high performance materials in the field.

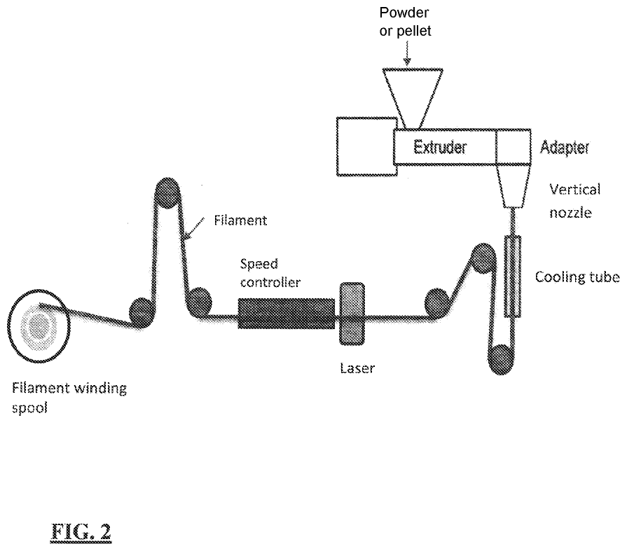

In one aspect, the filament containing the above-described thermoplastic polyimide can be made as illustrated in FIG. 2. Pellets or a powder material containing the thermoplastic polyimide may be added to an extruder and be heated to melt the pellets or powder. In a particular aspect, the extruder can be a single-screw extruder or a twin-screw extruder. The melt created in the extruder can be passed with a melt pump (not shown) under pressure from the extruder through an attached adapter containing at its end a nozzle to form the shape of the filament. In one aspect, as also shown in FIG. 2, the nozzle can be positioned in a vertical direction, and the molten filament exiting the vertical nozzle may be further guided through a cooling pipe. The cooling pipe can be cooled, for example, with cold air, such that the temperature of the pipe measured at its outer surface can be all the time during the filament forming between −40° C. to 0° C. The large temperature difference by passing the semi-liquid filament through the cooling pipe can cause an immediate solidification of the filament. The immediate solidification can have the advantage of forming a very homogeneous material and avoiding the inclusion of air bubbles. The cooling pipe can further allow replacing the quenching of the filament in water, and thereby obtaining a filament with a very low amount water. In aspects, the amount of water in the filament can be less than 2 wt % based on the total weight of the filament, such as less than 1 wt %, less than 0.5 wt %, less than 0.3 wt %, or less than 0.1 wt %.

After passing the cooling pipe, the filament can be further guided via a plurality of rolls to a filament winding spool. Before reaching the winding spool, the shape and diameter of the filament can be analyzed, for example with a laser, and a speed controller may measure the forming speed.

A further surprising advantage of the method of making the filament according to the present disclosure can be the high roundness of the formed filament with only minor variations in the diameter size throughout the filament. In one aspect, the filament can have an average diameter of at least 1.0 mm and not greater than 3.5 mm with a tolerance (total thickness variation throughout the filament) of not greater than ±0.10 mm. In a certain particular aspect, the filament can have an average diameter of at least 1.5 mm and not greater than 2.0 mm with a tolerance of not greater than ±0.05 mm.

In one embodiment, the pellets used for forming the filament can be formed during another extrusion process. In a certain aspect, the pellets can be made by adding the thermoplastic polyimide in form of a powder to an extruder, forming an extrudate, and sizing the obtained extrudate to a desired pellet size. In a particular aspect, the extruder can be a twin-screw extruder. In embodiments, the maximum temperature within the extruder during extrusion of the pellet material may not be greater than 400° C., such as not greater than 370° C., not greater than 360° C., not greater than 350° C., such as not greater than 330° C., not greater than 310° C., or not greater than 300° C. In a further aspect, the maximum temperature can be at least 250° C., or at least 270° C., or at least 300° C.

In one aspect, the pellets or powder composition for making the filament can contain next to the polyimide one or more additives which will be also contained in the formed filament. The additive can be at least one organic additive and/or at least one inorganic additive. In aspects, the additive can be a thermally conductive filler, an electrically conductive filler, a flow aid, a flame retardant, a stabilizer, or a color dye. Non-limiting specific examples of additives can be carbon fibers, glass fibers, glass beads, hollow glass beads, a UV stabilizer, a heat stabilizer, a ceramic, a mineral, mica, wollastonite, carbon nano tubes, graphite, graphene, graphene oxide, a metal, a metal alloy, one or more organic polymers different than the thermoplastic polyimide, or any combination thereof.

In a certain aspect, the additive can be a thin fiber material, for example, carbon fibers, glass fibers, or aramid fibers, in order to print a continuous fiber reinforced thermoplastic polyimide material.

In one aspect, an amount of the thermoplastic polyimide in the formed filament can be at least 40 wt % based on the total weight of the filament, such as at least 50 wt %, at least 60 wt %, at least 70 wt %, at least 80 wt %, at least 90 wt %, at least 95 wt %, or at least 99 wt %, with the remaining balance being one or more additives. In another aspect, an amount of the thermoplastic polyimide in the filament may be not greater than 99 wt %, or not greater than 95 wt %, or not greater than 90 wt %, or not greater than 80 wt %, or not greater than 70 wt %, or not greater than 65 wt %, or not greater than 60 wt %, or not greater than 55 wt %. The amount of the thermoplastic polyimide in the filament can be a value within any of the minimum and maximum values noted above.

In another aspect, the thermoplastic polyimide used in the starting material for forming the pellets or powder for making the filament can be substantially amorphous. As used herein, “substantially amorphous” is understood as a polyimide material having a crystallinity below 5%. The crystallinity or amorphous character of the polyimide material can be determined by DSC or X-ray measurements.

In certain aspects, the thermoplastic polyimide material of the present disclosure can contain a minor amount of crystalline parts, wherein the crystallinity may be not greater than 20%, such as not greater than 15%, or not greater than 10%, or not greater than 5%.

In a further embodiment, the molecular weight (M_{w}) of the thermoplastic polyimide can be at least 10,000 g/mol, or at least 30,000 g/mol, or at least 50,000 g/mol, or at least 100,000 g/mol, or at least 200,000 g/mol, or at least 300,000 g/mol, or at least 400,000 g/mol. In another embodiment, the molecular weight may be not greater than 800,000 g/mol, or not greater than 700,000 g/mol, or not greater than 500,000 g/mol, or not greater than 200,000 g/mol, or not greater than 100,000 g/mol. The molecular weight can be a value between any of the minimum and maximum values noted above. The molecular weight is determined according to size exclusion chromatography against a polystyrene standard.

In another embodiment, the thermoplastic polyimide of the present disclosure can have a relative viscosity of at least 1.1, or at least 1.3, or at least 1.5 or at least 1.8, or at least 2.0. In another embodiment, the relative viscosity of the thermoplastic polyimide may be not greater than 3.0, or not greater than 2.5, or not greater than 2.2. The relative viscosity is determined by dissolving 0.5 wt % of the thermoplastic polyimide in 95 wt % m-cresol, and comparing the flow time through a capillary viscometer of the sample containing the dissolved polyimide with the flow time of the pure solvent (not containing dissolved polyimide) according to ISO 307.

The present disclosure is further directed to a three-dimensional body comprising the above-described thermoplastic polyimide, wherein the three-dimensional body can be formed by a fused filament fabrication process and by using the above-described filament of the present disclosure. As further shown in the examples, it has been surprisingly observed that the three-dimensional body can have a highly isotropic character in its mechanical properties, such as tensile strength or elongation at break. In one aspect, a ratio of E₀ to E₉₀ can between 0.9:1 and 1:0.9, with E₀ being an elongation at break in print direction and E₉₀ being an elongation at break orthogonal to the direction, the elongation at break being measured according to ISO 527.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A filament comprising a thermoplastic polyimide, wherein the thermoplastic polyimide is a polymerization product of at least one diamine monomer and at least one dianhydride monomer, the diamine monomer being selected from

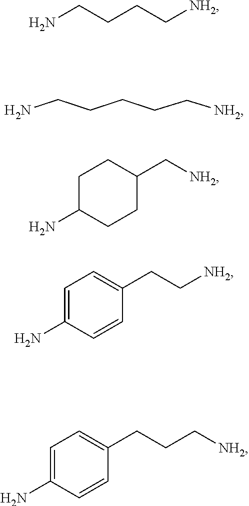 [SMILES: NCCCCN ; NCCCCCN ; NCC1CCC(N)CC1 ; NCCc1ccc(N)cc1 ; NCCCc1ccc(N)cc1]

or any combination thereof
the filament is adapted for use in a fused filament formation process; and
a glass transition temperature of the polyimide is not greater than 215° C.

Embodiment 2. The filament of Embodiment 1, wherein the dianhydride monomer has a structure of formula (1):

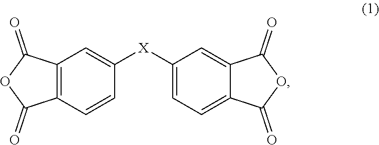

with X being CH₂, CHY, CY₂, or C₂-C₅ alkyl; Y being CH₃, CH₂F, CHF₂, or CF₃.

Embodiment 3. The filament of Embodiments 1 or 2, wherein the dianhydride monomer has a structure of formula (2)

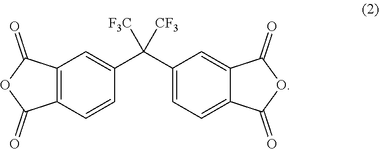 [SMILES: O=C1OC(=O)c2cc(C(c3ccc4c(c3)C(=O)OC4=O)(C(F)(F)F)C(F)(F)F)ccc21]

Embodiment 4. The filament of any one of the preceding Embodiments, wherein the thermoplastic polyimide includes a recurring structure unit of formula (3):

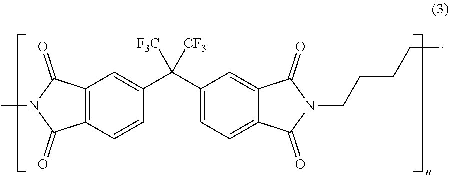

Embodiment 5. The filament of any one of the preceding Embodiments, wherein a molar ratio of the at least one diamine monomer to the at least one dianhydride monomer is between 2:1 and 1:6, or between 0.9:1.1 and 0.95:4.

Embodiment 6. The filament of any one of the preceding Embodiments, wherein a glass transition temperature of the thermoplastic polyimide is not greater than 210° C., or not greater than 205° C., or not greater than 200° C., or not greater than 195° C.

Embodiment 7. The filament of any one of the preceding Embodiments, wherein the thermoplastic polyimide is an amorphous polyimide.

Embodiment 8. The filament of any one of the preceding Embodiments, wherein the thermoplastic polyimide comprises a crystallinity of not greater than 20%, or not greater than 10%, or not greater than 5%.

Embodiment 9. The filament of any one of the preceding Embodiments, wherein an amount of the thermoplastic polyimide is at least 40 wt % based on the total weight of the filament, such as at least 50 wt %, at least 60 wt %, at least 70 wt %, at least 80 wt %, at least 90 wt %, at least 95 wt %, or at least 99 wt %.

Embodiment 10. The filament of Embodiment 9, wherein the filament consists essentially of the thermoplastic polyimide.

Embodiment 11. The filament of any one of Embodiments 1-9, wherein the filament further comprises at least one organic or at least one inorganic additive.

Embodiment 12. The filament of Embodiment 11, wherein the additive includes a thermally conductive filler, an electrically conductive filler, a flow aid, a flame retardant, a stabilizer, natural fibers, synthetic fibers, or a color dye.

Embodiment 13. The filament of Embodiments 11 or 12, wherein the additive is selected from carbon fibers, glass fibers, aramid fibers, sisal, wood fibers, glass beads, hollow glass beads, a UV stabilizer, a heat stabilizer, a ceramic, a mineral, mica, wollastonite, carbon nano tubes, graphite, graphene, graphene oxide, a metal, a metal alloy, an organic polymer different than the polyimide, such as PEEK or PEKK, or any combination thereof.

Embodiment 14. The filament of any of one of the preceding Embodiments, wherein the filament has a melting temperature according to ASTM D7426 of at least 130° C., or at least 140° C., 150°, or at least 160° C., or at least 170° C., or at least 180° C., or at least 190° C.

Embodiment 15. The filament of any one of the preceding Embodiments, wherein the filament has a melting temperature according to ASTM D7426 of not greater than 400° C., or not greater than 350° C., or not greater than 300° C., or not greater than 250° C., or not greater than 220° C., or not greater than 210° C., or not greater than 200° C., or not greater than 195° C.

Embodiment 16. The filament of any one of the preceding Embodiments wherein a cross-cut of the filament has a round shape or an oval shape.

Embodiment 17. The filament of any one of the preceding Embodiments, wherein the filament has an average diameter of at least 1.0 mm and not greater than 3.5 mm with a tolerance of not greater than ±0.10 mm.

Embodiment 18. The filament of Embodiment 17, wherein the filament has an average diameter of at least 1.5 mm and not greater than 2.0 mm with a tolerance of not greater than ±0.05 mm.

Embodiment 19. The filament of any one of the preceding Embodiments, wherein a material of the filament has a density of at least 1.05 g/cm3, or at least 1.1 g/cm3, or at least 1.2 g/cm3, or at least 1.4 g/cm3, or at least 1.5 g·cm3, or at least 1.6 g/cm3, or at least 1.8 g/cm3, or at least 2.0 g/cm3 or at least 2.5 g/cm3, or at least 3.0 g/cm3.

Embodiment 20. The filament of any one of the preceding Embodiments, wherein a material of the filament has a density of not greater than 4.0 g/cm3, or not greater than 3.5 g/cm3, or not greater than 3.0 g/cm3, or not greater than 2.5 g/cm3, or not greater than 2.0 g/cm3, or not greater than 1.8 g·cm3, or not greater than 1.6 g/cm3, or not greater than 1.55 g·cm3/or not greater than 1.51 g/cm³.

Embodiment 21. The filament of any one of the preceding Embodiments, wherein a material of the filament has a density of at least 1.1 g/cm3 and not greater than 2.0 g/cm3, or at least 1.2 g/cm3 and not greater than 1.7 g/cm3, or at least 1.3 g/cm3 and not greater than 1.55 g/cm3.

Embodiment 22. The filament of any one of the preceding Embodiments, wherein a water content of the filament is not greater than 1.0 wt % based on the total weight of the filament, or not greater than 0.5 wt %, or not greater than 0.3 wt %, or not greater than 0.1 wt %, or not greater than 0.05 wt %.

Embodiment 23. The filament of any one of the preceding Embodiments, wherein the filament is essentially free of pores having a size greater than 0.2 microns.

Embodiment 24. A method of forming a filament comprising:

providing a powder composition or a plurality of pellets, the powder composition or plurality of pellets including a thermoplastic polyimide;
heating the powder composition or plurality of pellets to prepare a melt; and
extruding the filament from the melt,
wherein the thermoplastic polyimide is a polymerization product of at least one diamine monomer and at least one dianhydride monomer, the diamine monomer being selected from

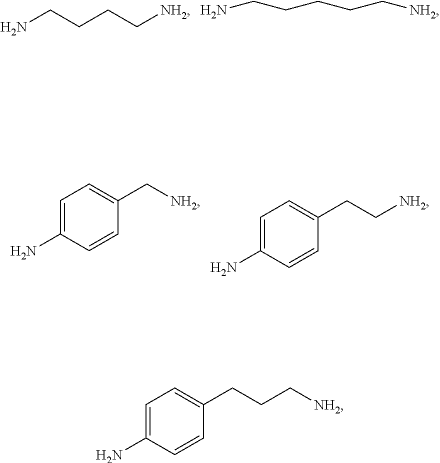 [SMILES: NCCCCCN ; NCCCCN ; NCc1ccc(N)cc1 ; NCCc1ccc(N)cc1 ; NCCCc1ccc(N)cc1]

or any combination thereof.

Embodiment 25. The method of Embodiment 24, wherein the dianhydride monomer has a structure of formula (1):

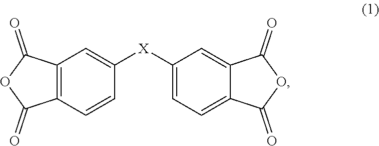

with X being CH₂, CHY, CY₂, or C₂-C₅ alkyl; Y being CH₃, CH₂F, CHF₂, or CF₃.

Embodiment 26. The method of Embodiments 24 or 25, wherein the dianhydride monomer includes a structure of formula (2)

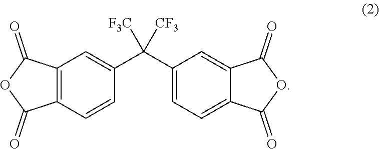 [SMILES: O=C1OC(=O)c2cc(C(c3ccc4c(c3)C(=O)OC4=O)(C(F)(F)F)C(F)(F)F)ccc21]

Embodiment 27. The method of any one of Embodiments 24-26, wherein the thermoplastic polyimide includes a recurring structure unit of formula (3):

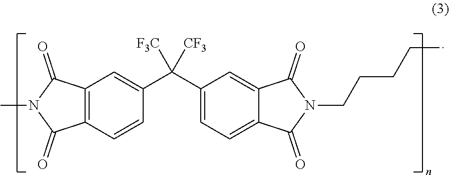

Embodiment 28. The method of any one of Embodiments 24-27, wherein extruding the filament from the melt comprises pumping the melt through a vertical nozzle and through a cooling pipe, wherein the cooling pipe comprises a temperature between −70° C. and 20° C., such as between −50° C. and 0° C., or between −40° C. and −20° C.

Embodiment 29. The method of any one of Embodiments 24 or 28, wherein extruding is conducted using a single screw extruder.

Embodiment 30. The method of any one of Embodiments 28 or 29, wherein the cooling pipe is cooled with a gas.

Embodiment 31. The method of any one of Embodiments 24-30, wherein a water content of the filament is not greater than 1.0 wt %, or not greater than 0.5 wt %, or not greater than 0.3 wt %, or not greater than 0.1 wt %.

Embodiment 32. The method of any one of Embodiments 24-31, wherein the melt is prepared from the powder, and the powder has an average particles size of at least 20 microns to not greater than 1000 microns.

Embodiment 33. The method of any one of Embodiments 24-31, wherein the melt is prepared from the pellets, the pellets having an aspect ratio of length to height of greater than 1.3, and an average length of the pellets is at least 2.0 mm and not greater than 7 mm, or of at least 3.0 mm and not greater than 6 mm, or at least 3.5 mm and not greater than 4.5 mm.

Embodiment 34. A three-dimensional body comprising a thermoplastic polyimide,

wherein
the thermoplastic polyimide is a polymerization product of at least one diamine monomer and at least one dianhydride monomer, the diamine monomer being selected from

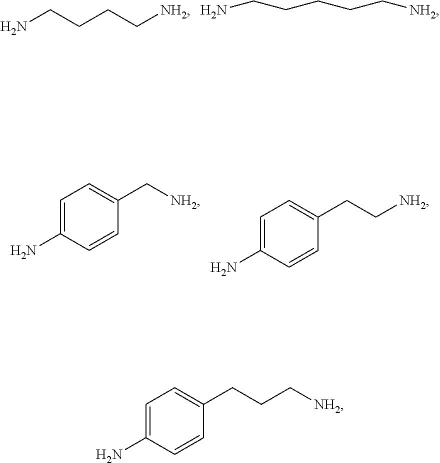 [SMILES: NCCCCCN ; NCCCCN ; NCc1ccc(N)cc1 ; NCCc1ccc(N)cc1 ; NCCCc1ccc(N)cc1]

or any combination thereof;
a glass transition temperature of the polyimide is not greater than 215° C.;
the three-dimensional body is formed by a fused filament formation process, and

a ratio of E₀ to E₉₀ is between 0.5:1 and 1:0.5, with E₀ being an elongation at break in printing direction and E₉₀ being an elongation orthogonal to the printing direction, the elongation at break being measured according to ISO527.

Embodiment 35. The three-dimensional body of Embodiment 34, wherein the ratio of E0 to E₉₀ is between 0.6:1 and 1:0.6, or between 0.7:1 and 1:0.7, or between 0.8:1 and 1:0.8, or between 0.9:1 and 1:0.9.

Embodiment 36. The three-dimensional body of Embodiments 34 or 35, wherein the dianhydride monomer has a structure of formula (1):

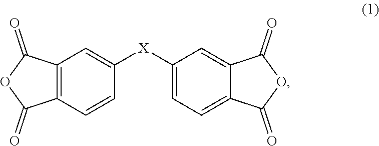

with X being CH₂, CHY, CY₂, or C₂-C₅ alkyl; Y being CH₃, CH₂F, CHF₂, or CF₃.

Embodiment 37. The three-dimensional body of any one of Embodiments 34-36, wherein the dianhydride monomer has a structure of formula (2)

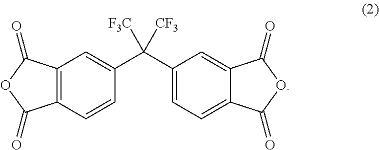 [SMILES: O=C1OC(=O)c2cc(C(c3ccc4c(c3)C(=O)OC4=O)(C(F)(F)F)C(F)(F)F)ccc21]

Embodiment 38. The three-dimensional body of any one Embodiments 34-37, wherein the thermoplastic polyimide includes a recurring structure unit of formula (3):

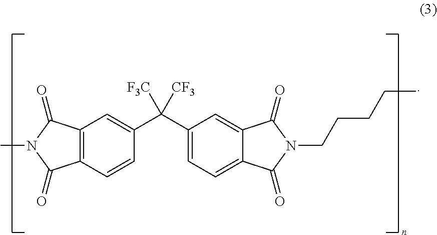

Embodiment 39. The three-dimensional body of any one of Embodiments 34-38, wherein an amount of the polyimide in the body is at least 98 wt % based on the total weight of the body, and a tensile strength of a material of the body according to ISO 527 in print direction is at least 60 MPa, and a tensile strength orthogonal to the print direction is at least 60 MPa.

Embodiment 40. The three-dimensional body of any one of Embodiments 34-39, wherein an amount of the polyimide in the body is at least 98 wt % based on the total weight of the body, and a tensile strength of a material of the body according to ISO 527 45 degree to the printing direction is at least 70 MPa.

Embodiment 41. The three-dimensional body of any one of Embodiments 34-40, wherein an amount of the polyimide in the body is at least 98 wt % based on the total weight of the body, and the elongation at break in printing direction is at least 3.5%, and the elongation at break orthogonal to the printing direction is at least 3.5%.

Embodiment 42. The three-dimensional body of any one of Embodiments 34-41, wherein an amount of the polyimide in the body is at least 98 wt % based on the total weight of the body, and the elongation at break 45 degrees to the printing direction is at least 4.0%, or at least 4.5%, or at least 5.0%, or at least 5.5%, or at least 6.0%.

Embodiment 43. The three-dimensional body of any one of Embodiments 34-42, wherein an amount of the polyimide in the body is at least 98 wt % based on the total weight of the body, and an HDT at 66 psi of a material of the body is at least 215° C., or at least 220° C., or at least 225° C.

Embodiment 44. The three-dimensional body of any one of Embodiments 34-43, wherein an amount of the polyimide in the body is at least 98 wt % based on the total weight of the body, and a density of a material of the body is at least 1.3 g/cm³ and not greater than 1.6 g/cm³.

Embodiment 45. A method of forming a three-dimensional body, comprising:

melt extruding a plurality of layers using a filament; and fusing the plurality of layers to obtain the three-dimensional body, wherein the filament comprises a thermoplastic polyimide, the thermoplastic polyimide having a glass transition temperature of not greater than 215° C. and being a polymerization product of at least one diamine monomer and at least one dianhydride monomer, the diamine monomer being selected from

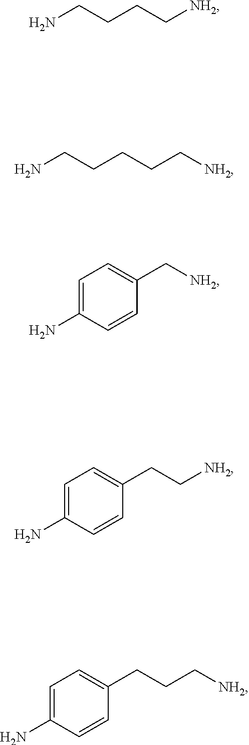 [SMILES: NCCCCN ; NCCCCCN ; NCc1ccc(N)cc1 ; NCCc1ccc(N)cc1 ; NCCCc1ccc(N)cc1]

or any combination thereof.

Embodiment 46. The method of Embodiment 45, wherein the dianhydride monomer has a structure of formula (1):

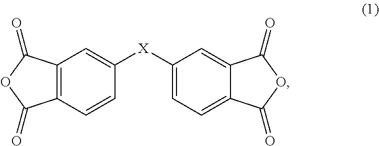

with X being CH₂, CHY, CY₂, or C₂-C₅ alkyl; Y being CH₃, CH₂F, CHF₂, or CF₃.

Embodiment 47. The method of Embodiments 45 or 46, wherein the dianhydride monomer includes a structure of formula (2)

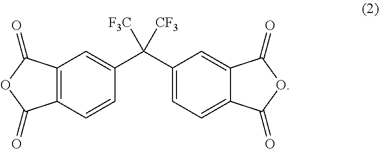 [SMILES: O=C1OC(=O)c2cc(C(c3ccc4c(c3)C(=O)OC4=O)(C(F)(F)F)C(F)(F)F)ccc21]

Embodiment 48. The method of any one of Embodiments 45-47, wherein the thermoplastic polyimide includes a recurring structure unit of formula (3):

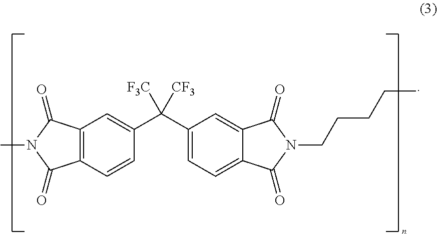

Embodiment 49. The method of any one of Embodiments 45-48, wherein a forming speed of the three-dimensional body is at least 10 mm/s, or at least 12 mm/s, or at least 15 mm/s.

Embodiment 50. The method of any one of Embodiments 45-49, wherein a chamber temperature is at least 70° C. and not greater than 220° C.

Embodiment 51. The method of Embodiment 50, wherein the chamber temperature is not greater than 200° C., such as not greater than 190° C., not greater than 180° C., not greater than 170° C., or not greater than 165° C.

### EXAMPLES

### Example 1

Preparing of Polyimide Particles

Into a 3 neck flask equipped with a reflux condenser and an overhead stirrer with thermometer and torque display, 4,4′-(hexafluoroisopropylidene)diphthalic anhydride (6-FDA) (44.42 g, 100 mmol, 1 eq) and 190 mL m-cresol were combined under nitrogen atmosphere. Thereafter, 95 mmol (8.15 g, 95 mol %) of 1,4-diaminobutane (DAB) was added to the reaction flask. The DAB was added as a 0.5 M solution in m-cresol (12 mL) via dropping funnel under nitrogen atmosphere. After adding the DAB, the flask content was stirred and heated to 155° C. and maintained for at least 1.5 hours at this temperature. Thereafter, the reaction was stopped by cooling to about 70° C. and quenching with about 650 mL ethanol, thereby precipitating a colorless powder of the formed polyimide.

The obtained polyimide had the recurring structure unit of Formula (3).

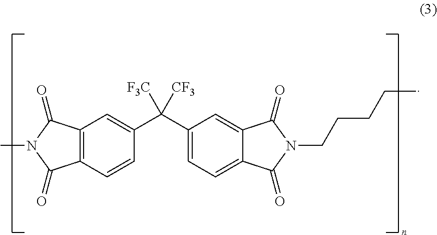

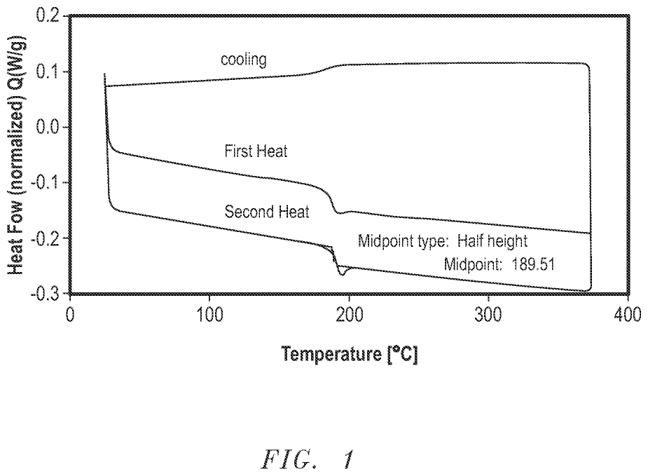

The glass transition temperature (T_{g}) was determined by analyzing the powder via differential scanning calorimetry (DSC) according to ISO 11356-2. A DSC curve of the polyimide can be seen in FIG. 1. The powder sample was heated at a speed of 10° C./minute up to about 380° C. and the heat flow corresponding normalized heat flow was measured. It can be seen that the Tg is reversible, and is at the same temperature (189° C.) when a second heating was conducted, indicating thermoplastic behavior. Upon cooling, no crystallization peak could be observed, but the material rehardened at the Tg of 189° C. This further indicates that the powder sample is highly amorphous.

### Example 2

Preparing of Pellets for Fused Filament Fabrication

The thermoplastic polyimide powder of Example 1 having an average particle size of 53.5 microns was added to a twin-screw extruder and extruded whereby a maximum temperature between 360° C. to 390° C. was reached. The extrudate had a thickness of 2-3 mm and was dried at 150° C. for 4-6 hours, and thereafter cut with a granulator into pellets having a size of about 2.0 mm×4.0 mm.

### Example 3

Forming of Filaments

The pellets made in Example 2 were continuously added via a gravimetric feeder to a 20 mm single-screw extruder. In the single-screw extruder, the pellets were heated up to a temperature of 330-360° C. to melt the pellets. The obtained melt was passed with a melt pump via a pressure of about 40-50 MPa from the extruder through an attached adapter containing at its end a nozzle to form the shape of the filament. The nozzle was positioned in vertical direction, and the molten filament exiting the vertical nozzle was further guided through a cooling pipe. The pipe was cooled with cold air such that the temperature of the pipe was all the time between −40° C. to 0° C. The large temperature difference by passing the semi-liquid filament through the cooling pipe caused an immediate solidification of the filament. The filament was further guided via a plurality of rolls to a filament winding spool. Before reaching the winding spool, the shape and diameter of the filament was analyzed with a laser (Zumbach laser), and a speed controller measuring the forming speed. An illustration of the filament forming process is also shown in FIG. 2.

The use of the cooling pipe had the advantage that the filament did not need to be quenched in water, thereby keeping the filament essentially free of water. The rapid cooling further improved the quality of the filament by obtaining a very homogeneous material with nearly no entrapped air.

The thickness and shape variations of filaments formed in three repeated experiments (analyzed with the Zumbach laser) are summarized in Table 1. The results show that filaments can be repeatedly produced having the same diameter and low tolerance in its thickness.

A comparative filament (C1) was made using instead of the pellets the powder composition of the polyimide obtained in Example 1. As can be also seen in Table 1, the obtained comparative filament was very uneven in its diameter size, which was mainly caused by large air bubbles that were trapped within the filament.

TABLE 1

| | Length of | Average | Maximum | Minimum | |
|---|---|---|---|---|---|
| | Filament | diameter | diameter | diameter | Variation [mm] |
| | [m] | [mm] | [mm] | [mm] | (Dₘₐₓ − Dₘᵢₙ) |
| E1 | 156.6 | 1.748 | 1.818 | 1.651 | 0.167 |
| E2 | 195.6 | 1.743 | 1.824 | 1.633 | 0.191 |
| E3 | 200.9 | 1.748 | 1.835 | 1.636 | 0.087 |
| C1 | 203.22 | 1.92 | 5.029 | 0.545 | 4.484 |

### Example 4

Forming of Three-Dimensional Polyimide Bodies Via Fused Filament Fabrication.

Three-dimensional polyimide bodies were printed via fused filament fabrication (FFF) using the filament of Example 3 (E1-E3).

Since it is known that during additive manufacturing the material properties throughout the body are typically anisotropic and that the strength of the body is typically highest in the printing direction, and lowest orthogonal to the printing direction, 3D-printed test specimens were printed in three different ways to conduct the testing:

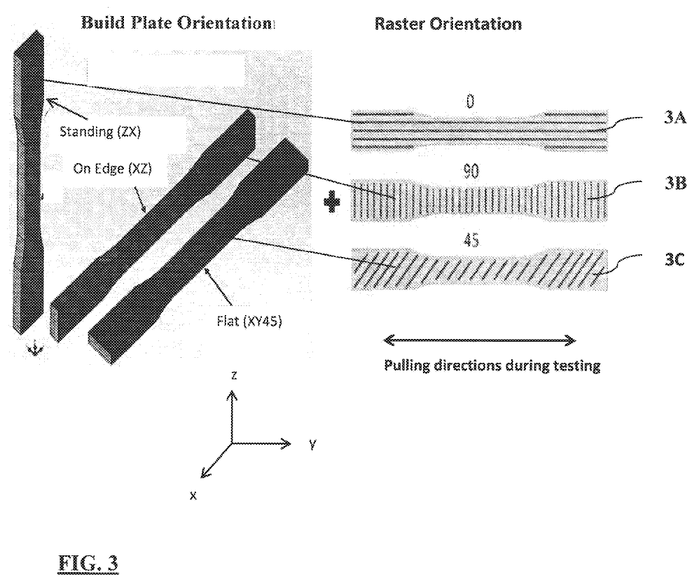

1) The testing of the mechanical properties in print direction were done with specimens (also called interchangeable herein “test bars”), which were formed by printing along the longest dimension, as shown in FIG. 3, specimen 3A. The lines drawn throughout the specimen indicate the direction in which the specimen was printed. The orientation of the formed specimen is also called herein “ZX orientation.”

2) The testing orthogonal to the print direction was conducted with test specimens which were printed in the width direction of the test bars, see FIG. 3, specimen 3B. The orientation of the formed specimen is also called herein “XZ orientation.”

3) The testing of 45 degrees to the printing direction was done on specimens shown in FIG. 3 as specimen 3C, which was formed with an alternating −45/45 degree angle, which is called herein also “XY45 orientation.” A summary of the three test specimens (test bars) is given in Table 2.

TABLE 2

| | | Orientation of |
|---|---|---|
| Type of Testing | Tested Specimen | formed Specimen |
| In print direction | 3A | ZX |
| Orthogonal to print | 3B | XZ |
| direction | | |
| 45 degrees to print | 3C | XY |
| direction | | |

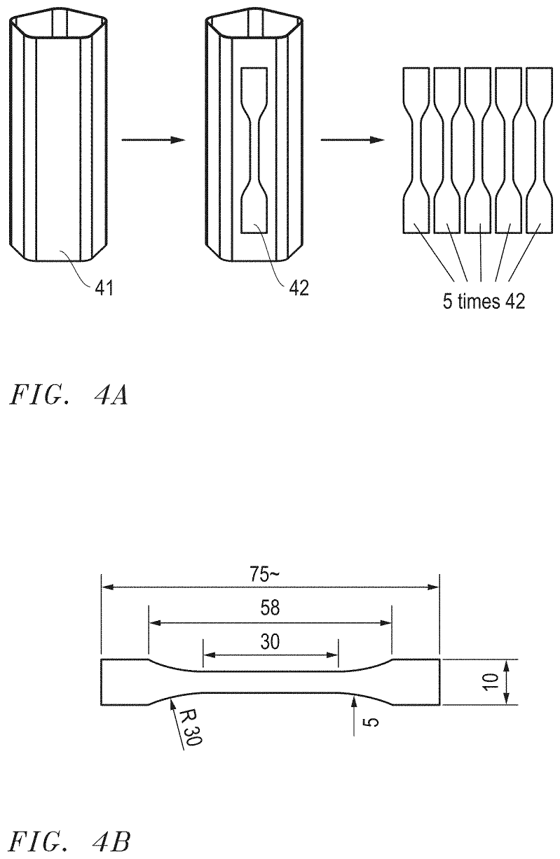

The above-described test specimens (test bars) made with different print directions were printed as bars lying flat on a printing bed. Three types of test bars were printed with the shape as shown in FIG. 4B and a thickness of 2 mm, with print orientation as illustrated in 3A, 3B, and 3C of FIG. 3. FIG. 4B is a line drawing showing the exact dimensions of the test specimens for conducting the tensile testing as required according to ISO 527.

Fused filament fabrication printing was conducted in a Juggerbot F1-11 printing machine from Juggerbot 3D LLC. The printing conditions were as following: printing temperature at nozzle: 370-390° C.; chamber temperature: 90° C.; heated bed: 120-140° C.; printing speed between 4 and 15 mm/s. For the printing, the filament was reduced in its thickness to a diameter of about 0.5 mm, and the printing was conducted that the height of each layer (in print direction) was 0.2 mm.

The above-described three-dimensional polyimide test specimens (E4) were tested for tensile modulus, tensile strength, and elongation at break in three different directions of the printed body. A summary of the test results is shown in Table 3, wherein each value is an average of 5 repeated tests. Table 3 also contains comparative data taken from Stratasys datasheets for FFF printed Extem AMHH811F (C₂), and Ultem 1010 (C3).

TABLE 3

| | | | | C2 | | C3 | |
|---|---|---|---|---|---|---|---|
| | E4 | | | (Extem) | | (Ultem 1010) | |
| | ZX | XZ | XY | ZX | XY | ZX | XZ |
| Tensile Strength [MPa] | 72 | 71 | 83 | 47 | 48 | 79.2 | 28.2 |
| Elongation at Break | 3.9 | 3.9 | 5.9 | 2.8 | 3.0 | 4.0 | 1.1 |
| Tensile Modulus [MPa] | 2.8 | 2.7 | 2.8 | | | 3.04 | 3.00 |

It could be surprisingly observed that the three-dimensional polyimide bodies of test samples E4 were to a large degree isotropic, which means very even in their properties independent of the printing direction.

Furthermore, both tensile strength and elongation at break were even higher than obtained for commercial product Extem AMHH811F (a combination of a polyetherimide and PEEK) under the same testing conditions.

Measuring of Tensile Strength:

The tensile strength was measured according to ISO 527, at 55 MPa. As test samples were used FFF printed bodies as shown in FIG. 4B, printed with different orientations, see 3A, 3B, 3C in FIG. 3.

Measuring of Elongation at Break

The elongation at break was measured also according to ISO 527. As test samples were used FFF printed bodies as shown in FIG. 4B, printed with different orientations, see 3A, 3B, 3C in FIG. 3.

Measurement of Tensile Modulus

The modulus was measured using an Instron machine, Model #5967, which calculated the modulus from the optical strain sensor.

Heat Deflection Temperature (HDT)

An HDT of 225° C. is predicted by measurement of the temperature at a bulk modulus at 264 psi and 66 psi by dynamic-mechanical analysis of a 50 microns thick cast polyimide film of the polyimide made in Example 1. The HDT can be measured according to ASTM D648 Method B.

### Example 5

FIG. 4A illustrates a further option how test specimens illustrated in FIG. 3 can be printed. In this embodiment, the printing can be conducted by forming a pentagonal or hexagonal structure (41) consisting of just one track (layer) in the width direction of the walls of the pentagon or hexagon with a thickness of about 0.5 mm, and printing a plurality of layers (filaments) deposited in the height direction on top of each other.

In the present example, hexagonal structures were printed and from each of the six surface sections of the hexagon one test specimen (42) was punched out with a hand press, such that six specimens were obtained per printed hexagonal structure.

For the printing of the hexagonal body, the filament of example 3 was used. The printing was conducted using an Intamsys funmat HT with the following settings: Temperature of nozzle: 400° C., Temperature of chamber: 90° C., Temperature of bed: 160° C., layer thickness 0.2 mm, printing speed 30 mm/s. Test bars (test bar samples E5) were cut out from the printed hexagonal structures such that single layer bars (having a single filament layer along its thickness direction) printed in ZX direction and XZ direction were obtained.

A further set of hexagonal structures were printed using a Minifactory Ultra with the following settings: Temperature of nozzle: 405° C., Temperature of chamber: 90° C., Temperature of bed: 160° C., layer thickness 0.2 mm, printing speed 30 mm/s. Similarly as for sample E5, test bar samples were cut from the hexagonal bodies to obtain test bars printed in XZ direction and ZX direction (test bar samples E6).

Table 4 summarizes the measured tensile modulus, tensile strength and elongation at break of the test bars. It can be seen that similar strength values were obtained independent if the printing was in XZ or ZX direction. It was further highly surprising to observe that the test bars of samples E5 and E6 had higher tensile strength values than the flat bed printed test bars (E4), although the thickness of test bars E5 and E6 was only a single filament layer. These high strength values can make these types of bodies very suitable for thin-wall applications, such as connectors of thin-wall boxes.

TABLE 4

| | E5 | | E6 | |
|---|---|---|---|---|
| | XZ | ZX | XZ | ZX |
| Tensile strength [MPa] | 107 | 77 | — | 96 |
| Elongation at break | 6.2 | 3.6 | — | 2.3 |
| Tensile Modulus [MPa] | 2.5 | 2.55 | — | 2.3 |

### Example 6

The filament of example 3 was further used for printing a free standing plate using a Minifactory Ultra machine under the following printing conditions: Temperature at nozzle: 405° C.; Temperature of chamber: 160° C.; Temperature of heated bed: 160° C.; printing speed 30 mm/s. The printed plate was dried 125° C. for 4 hours in a machine dryer. After the drying, the printed plate had a thickness of 3 mm, a height of 85 and a length of 85. From each printed plate, five test bars (samples E7) were cut with a water jet to obtain test bars as shown in FIG. 4B (corresponding to test bar according to ASTM D638 type V). The cutting was conducted such that test bars were obtained having 1) the length direction in printing direction (XZ) and 2) the length direction orthogonal to the printing direction (ZX), as in examples 4 and 5.

The test bars were measured for tensile modulus, tensile strength and elongation at break. A summary of the test results is shown in Table 5 and compared with data taken from Stratasys datasheets for FFF printed Ultem 1010 (C3), ULTEM 9085 (C4), and Antero 800NA (C5), obtained from the Stratasys website.

TABLE 5

| | | | C3 | | C4 | | C5 | |
|---|---|---|---|---|---|---|---|---|
| | E7 | | (Ultem 1010) | | (Ultem 9085) | | (Antero 800NA) | |
| | XZ | ZX | XZ | ZX | XZ | ZX | XZ | ZX |
| Tensile strength [MPa] | 101.89 | 58.77 | 79.2 | 28.2 | 68.1 | 39.4 | 73 | 59.7 |
| Elongation at break | 4.73 | 2.68 | 4 | 1.1 | 5.4 | 1.9 | 6.1 | 2.3 |
| Tensile Modulus [MPa] | 2.82 | 2.57 | 3.04 | 3.00 | 2.52 | 2.41 | 2.64 | 2.77 |

The date summarized in Table 5 show that test bars of sample E7 show significantly higher mechanical strength properties, especially of the tensile strength in XZ direction, compared to the best results of printed Stratasys materials in the same class of printed materials.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

What is claimed is:

1. A filament comprising a thermoplastic polyimide, wherein
the thermoplastic polyimide is a polymerization product of at least one diamine monomer and at least one dianhydride monomer, the diamine monomer being selected from 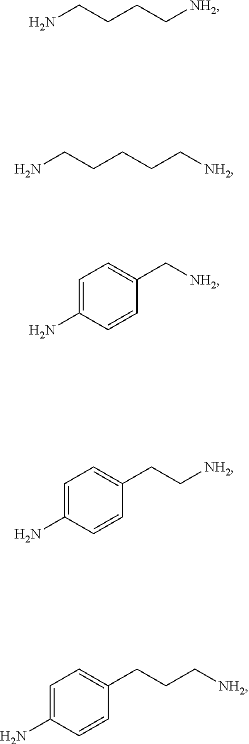 [SMILES: NCCCCN ; NCCCCCN ; NCc1ccc(N)cc1 ; NCCc1ccc(N)cc1 ; NCCCc1ccc(N)cc1]
or any combination thereof
the filament is adapted for use in a fused filament formation process; and
a glass transition temperature of the polyimide is not greater than 215° C.

2. The filament of claim 1, wherein the dianhydride monomer has a structure of formula (1): 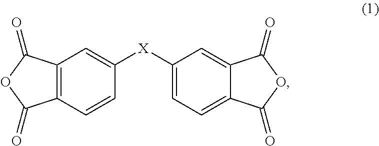
with X being CH₂, CHY, CY₂, or C2-C5 alkyl; Y being CH₃, CH₂F, CHF₂, or CF₃.

3. The filament of claim 2, wherein the dianhydride monomer has a structure of formula (2)

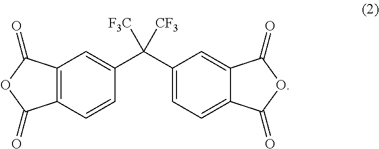 [SMILES: O=C1OC(=O)c2cc(C(c3ccc4c(c3)C(=O)OC4=O)(C(F)(F)F)C(F)(F)F)ccc21]

4. The filament of claim 1, wherein the thermoplastic polyimide includes a recurring structure unit of formula (3):

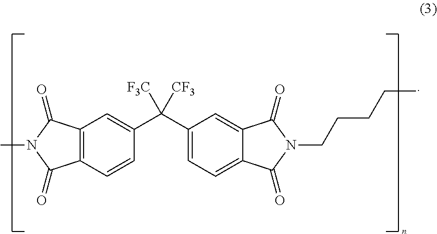

5. The filament of claim 1, wherein a glass transition temperature of the thermoplastic polyimide is not greater than 210° C.

6. The filament of claim 1, wherein the thermoplastic polyimide comprises a crystallinity of not greater than 20%.

7. The filament of claim 1, wherein an amount of the thermoplastic polyimide is at least 40 wt % based on the total weight of the filament.

8. The filament of claim 1, wherein the filament consists essentially of the thermoplastic polyimide.

9. The filament of claim 1, wherein the filament further comprises an additive, the additive including a thermally conductive filler, an electrically conductive filler, a flow aid, a flame retardant, a UV stabilizer, a heat stabilizer, natural fibers, synthetic fibers, a color dye, or any combination thereof.

10. The filament of claim 9, wherein the additive is selected from carbon fibers, glass fibers, aramid fibers, sisal, wood fibers, glass beads, hollow glass beads, a ceramic, a mineral, mica, wollastonite, carbon nano tubes, graphite, graphene, graphene oxide, a metal, a metal alloy, an organic polymer different than the polyimide, or any combination thereof.

11. The filament of claim 1, wherein the filament has an average diameter of at least 1.0 mm and not greater than 3.5 mm with a diameter tolerance of not greater than ±0.10 mm.

12. The filament of claim 1, wherein a water content of the filament is not greater than 1.0 wt % based on the total weight of the filament.

13. The filament of claim 1, wherein the filament is essentially free of pores having a size greater than 0.2 microns.

14. A method of forming a filament comprising:
providing a powder composition or a plurality of pellets, the powder composition or plurality of pellets including a thermoplastic polyimide;
heating the powder composition or plurality of pellets to prepare a melt; and
extruding the filament from the melt,
wherein the thermoplastic polyimide is a polymerization product of at least one diamine monomer and at least one dianhydride monomer, the diamine monomer being selected from 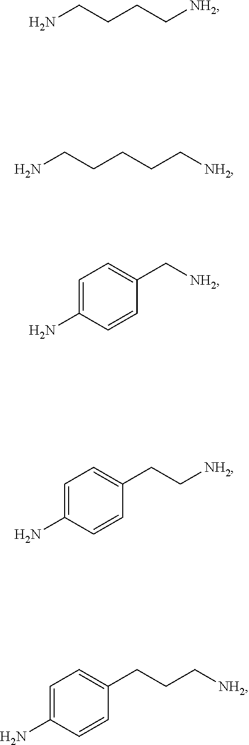 [SMILES: NCCCCN ; NCCCCCN ; NCc1ccc(N)cc1 ; NCCc1ccc(N)cc1 ; NCCCc1ccc(N)cc1]
or any combination thereof.

15. The method of claim 14, wherein the dianhydride monomer has a structure of formula (1): 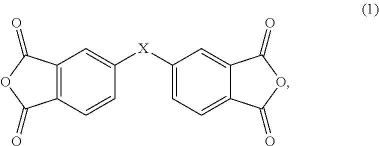
with X being CH₂, CHY, CY₂, or C2-C5 alkyl; Y being CH₃, CH₂F, CHF₂, or CF₃.

16. The method of claim 14, wherein extruding the filament from the melt comprises pumping the melt through a vertical nozzle and through a cooling pipe, wherein the cooling pipe comprises a temperature between −70° C. and 20° C.

17. The method of claim 14, wherein the melt is prepared from the pellets, the pellets having an aspect ratio of length to height of greater than 1.3, and an average length of the pellets is at least 2.0 mm and not greater than 7 mm.

18. A three-dimensional body comprising a thermoplastic polyimide, wherein
the thermoplastic polyimide is a polymerization product of at least one diamine monomer and at least one dianhydride monomer, the diamine monomer being selected from 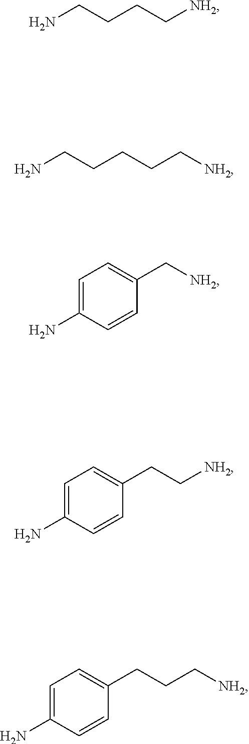 [SMILES: NCCCCN ; NCCCCCN ; NCc1ccc(N)cc1 ; NCCc1ccc(N)cc1 ; NCCCc1ccc(N)cc1]
or any combination thereof;
a glass transition temperature of the polyimide is not greater than 215° C.;
the three-dimensional body is formed by a fused filament formation process, and
a ratio of E₀ to E₉₀ is between 0.5:1 and 1:0.5, with E₀ being an elongation at break in printing direction and E₉₀ being an elongation orthogonal to the printing direction, the elongation at break being measured according to ISO527.

19. The three-dimensional body of claim 18, wherein the thermoplastic polyimide includes a recurring structure unit of formula (3):

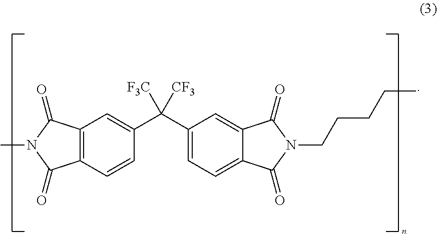

20. The three-dimensional body of claim 18, wherein an amount of the polyimide in the body is at least 98 wt % based on the total weight of the body, and a tensile strength of a material of the body according to ISO 527 in print direction is at least 60 MPa, and a tensile strength orthogonal to the print direction is at least 55 MPa.
